(19) United States
(12) Patent Application Publication
(10) Pub. No.: US 2024/0118697 A1
(43) Pub. Date: Apr. 11, 2024

(54) AUTOMATION SYSTEM FOR VEHICLES USING REUSABLE MISSION ELEMENTS

(71) Applicant: Kubota Corporation, Osaka (JP)

(72) Inventor: Edwin Ernest Wilson, Arlington, TX (US)

(21) Appl. No.: 18/373,704

(22) Filed: Sep. 27, 2023

Related U.S. Application Data
(60) Provisional application No. 63/414,054, filed on Oct. 7, 2022.

(51) Int. Cl. G05D 1/02

(52) U.S. Cl. CPC G05D 1/0219; G05D 2201/0201

(57) ABSTRACT

An automated machine management and operational control system. The system uses reusable digital assets to efficiently generate mission plans using predictable instructions. The reusable digital assets are created for applicability to multiple machines, locations, implements and operations. Machine, implement or location specific configurations may be used in combination with reusable digital assets to form mission plan instructions.

### CROSS-REFERENCE TO RELATED APPLICATIONS

This application claims the benefit of priority from U.S. Provisional Patent Application No. 63/414,054 filed on Oct. 7, 2022, which is incorporated herein by reference.

### FIELD OF THE DISCLOSURE

The invention relates generally to automated vehicle and machine activities.

### BACKGROUND

Autonomous machines exist within the off-highway or other off-road machinery spaces (e.g., agriculture, turf, construction, and mining) that involve a single machine working on a task autonomously or in a semi-autonomous manner with human oversight. In some cases, multiple autonomous machines are working on a single mission, but are constrained to work in a specified zone to prevent direct interaction with other machines within the mission.

Machine automation systems (e.g., vehicle automation systems) use an onboard operations system to drive and manage the machine (e.g., the vehicle). The system may also include onboard sensors to identify potential obstacles and provide feedback for driving and operating the machine.

Machine automation has been applied to operations within fields or specific job sites, including pre-planned lines to traverse a field that may include waypoints or boundary markers. In some embodiments, systems have assisted in identifying turns and headland operations to manage transitions between operation paths, such as parallel mowing lines. Machine automation is designed for a given project operation for the specified field. This project may be stored for a repeat of the same project operation for the specified field by the machine at a future date.

### SUMMARY

The automation planning and operations do not cover preparation and transition needs outside of the operational field. For example, a human operator or transporter must transport a machine to the starting point of the operational field and further transport the machine to any separate fields. This keeps operations to individual fields limiting the potential scope and benefits of autonomy.

In addition to scope limitations for independent fields, repeatability is limited to the same operation being conducted again in the same field by the machine. For example, a stored program for a machine to mow a field may be implemented each time the machine needs to mow the field.

The present disclosure provides an automation system to assign and manage machines' (e.g., vehicles) operations through mission plan development designed to improve efficiencies and planning flexibility. The present disclosure provides a system to create reusable digital assets forming subsections of overall projects that may be applied to other operations, fields, machines and projects. The present disclosure further includes a more robust scope of automated elements to facilitate pre- and post-work operations, as well as transition operations to allow a project to expand to multiple independent fields. These additional non-work operations may be reusable digital assets, which are applicable to multiple machines.

The present disclosure further provides systems that develop mission plans for robust projects from expanded start to finish operations. The mission plans may be built using reusable digital assets. In some embodiments, the mission plan may integrate reusable digital assets, which may cover agnostic or flexible operations, with additional tailored operation actions to create mission plans tailored to specific machine, location or operation requirements.

The present disclosure creates the ability to increase efficient preparation of mission plans with flexibility to achieve varied operations. The mission plans have an increased safety over time as the integrated reusable digital assets have been implemented previously and provide predictable application to related machines and projects. Machine profiles with detailed machine information may increase the predictability by facilitating direct characteristic comparison between machines that have conducted operations with the reusable digital asset previously and machines that may use the reusable digital asset for future projects.

Embodiments may provide a communication and control system for a plurality of working machines, which include machines designed for agricultural, mining, construction, turf and logistics projects, among others. The machines may be mobile machines (e.g., off-highway or other off-road mobile machines) that may perform automated collaborative behaviors. The working machines are often vehicular machines, which may be capable of moving from location to location in addition to their working operations.

Embodiments may include a plurality of working machines. Each working machine may include a communication device configured to transmit status information of the working machine and receive a set of machine instructions. These updates and instructions may be sent through any available communication corresponding to the available communication modules on the working machine.

The working machine may also include a controller to control operation of the working machine. The controller may be a system with a computer to process and drive control actuators throughout the working machine. In addition, the controller may receive feedback regarding operations through various operational sensors, such as onboard perception systems, proximity sensors, location systems, working load sensors and other sensor systems to collect operational information in real-time.

In some embodiments, a working machine may send status updates to a remote system and receive machine-specific instructions from the remote system. The remote system may process and dispatch a mission plan to the working machine, which may include the machine-specific instructions.

In some embodiments, if the working machine is operated in a manner different from one programed by the set of machine instructions, the communication device for the working machine may be configured to transmit an updated set of machine instructions to the remote system over the cellular communication network. In some embodiments, if the working machine is operating in a manner different from behavior instructed in the mission plan, the remote system may observe such variances contained in the machine status information it receives over the cellular network. The remote system may modify the mission plan to capture changes in operation.

In some embodiments, the update may include a reason or indication for the modification based on observation through sensors on the working machine. The remote system may evaluate the modification to determine if the change is due to a permanent or semi-permanent consideration. In such embodiments, the remote system may incorporate the modification into a reusable instruction set.

Some embodiments include a networked ecosystem including a plurality of working machines with automated systems, such as machines designed for agricultural, construction, turf and logistics projects. Embodiments of the networked ecosystem may also include a remote cloud management system and a control system. The remote cloud management system may receive communications from the working machines and the control system. In some embodiments, the remote cloud management system may also receive communications from other sources, such as a machine deployment system.

In some embodiments, the remote cloud management system includes storage to hold and manage activity instructions, machine profile information and mission planning rules and limitations. In some embodiments, the cloud management system includes a collection of selectable mission activities and interactions, which may be applied as part of mission plan instructions when the requisite working machines that may achieve the activity are present. In some embodiments, the collection may be stored in a database format.

In some embodiments, the storage may include reusable digital assets, which relate to the location, travel options, field layout, project constraints and/or other information. The reusable digital assets may be compiled together or with other operation instructions to create activity instructions and mission plans.

In some embodiments, the cloud management system facilitates mission planning development. The cloud management system may receive mission plan requests framing a project for a mission plan to accomplish from a control system. The control system may include a dedicated user interface. In some embodiments, a remote user interface accesses the control system via a wireless network connection, such as a mobile phone application.

In some embodiments, framing the project for a mission plan may include identifying account information, a project location or boundaries, available materials and machines, project goals, project constraints and other information. In some embodiments, the control system may be used to define a mission plan using information from the cloud management system.

In some embodiments, the remote cloud management system may include an automation system that develops mission plans based on machine profiles and mission activities. The automation system may identify applicable reusable digital assets as starting blocks upon which to develop the mission plan.

Embodiments may include a training system to determine applicable machine characteristics using a sensor system and defined operational protocols. The training system may be used to create reusable digital assets for the training machine. The system may further identify additional applications for the reusable digital assets through extrapolation of the training machine's characteristics to identify similar applicable characteristics in other machines.

In some embodiments, the reusable digital assets may be machine learning models. The machine learning models may be tailored to specific conditions, implementations or features of a project, machine, or field. In some embodiments, the machine learning models may be used to manage sensor systems, including sensor configurations, sensor data analysis and other information for tailored situations.

### A BRIEF DESCRIPTION OF THE DRAWINGS

Embodiments will now be described, by way of example only, with references to the accompanying drawings in which:

FIG. 1 is an embodiment of a system diagram;

FIG. 2 is an embodiment of a dynamic project map diagram;

FIG. 3 is an embodiment of a system operation flowchart for mission planning; and

FIG. 4 is an embodiment of a system operation flowchart asset creation.

### DETAILED DESCRIPTION

While this invention may be embodied in many different forms, there will herein be described in detail preferred embodiments of the invention with the understanding that the present disclosure is to be considered as an exemplification of the principles of the invention and is not intended to limit the broad aspects of the invention to the embodiments illustrated. It will be understood that the invention may be embodied in other specific forms without departing from the spirit or central characteristics thereof. The present embodiments, therefore, are to be considered in all respects as illustrative and not restrictive, and the invention is not to be limited to the details given herein.

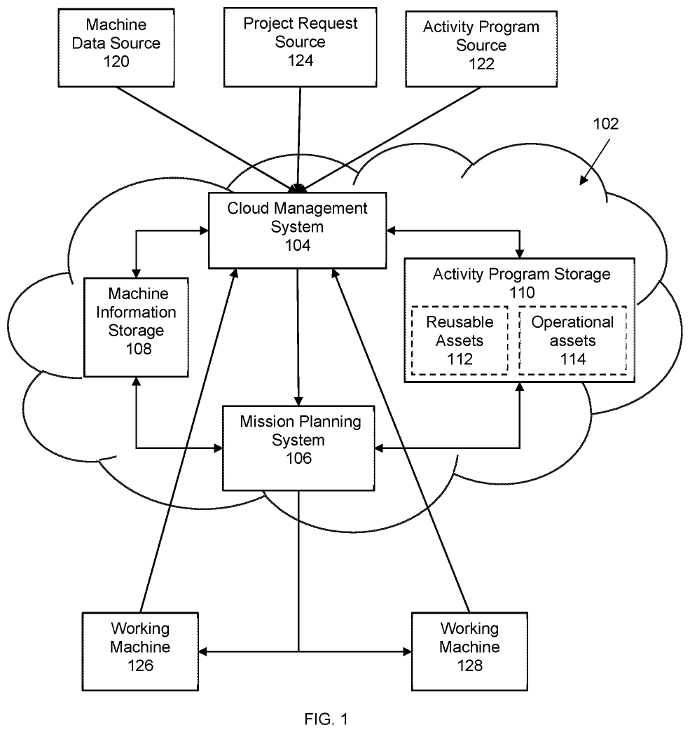

FIG. 1 illustrates an embodiment of a system using a cloud system 102 to manage working machines 126 and 128. In this embodiment, the cloud system 102 includes a cloud management system 104, a mission planning system 106, a machine information storage 108 and an activity program storage 110. This embodiment shows the activity program storage 110 including reusable assets storage 112 and operational assets storage 114. In some embodiments, the mission planning system 106 may include subsystems to manage development of one or more features of the mission plan. For example, some embodiments, may include machine information analysis systems, activity program analysis systems, a path planning system or other system components.

In some embodiments, these system components may be discrete components within the cloud system 102 or one or more dedicated servers. In other embodiments, the system components may be integrated. In some embodiments, certain component systems are maintained inside the mission planning system 106, while other system components are operatively connected to provide a service to the mission planning system 106 over a wireless connection, a wired network connection or direct wired connection, such as over a bus interface.

The machine information storage 108 and the activity program storage 110 may be any type of electronic storage structure or memory device. In addition, the machine profiles, data, reusable digital assets, operational assets and other information stored in the machine information storage 108 and the activity program storage 110 may be stored within the memory structure in a variety of formats, such as a database, an indexed file system or other format. In some embodiments, the reusable digital assets and the operational assets may include specific scripts to integrate into a mission plan and instruct the machine control system how to operate. In some embodiments, the reusable digital assets and/or the operational assets may include models developed by machine learning systems. The machine learning models may be configured for perception sensors, operation sensors or maintenance system sensors to improve sensor functions.

The mission planning system 106 may access or receive information from the machine information storage 108 and the activity program storage 110. In some embodiments, the mission planning system 106 may also send information to the machine information storage 108 or the activity program storage 110. For example, finalized mission plans or portions thereof may be sent to the activity program storage for later evaluation or use.

In some embodiments, the machine information storage 108 maintains machine profiles for a plurality of working machines. The machine profiles for each machine may include detailed identification information, operational information and other machine-specific characteristics, which operate as a configuration or information file for the machine. The identification information may include the machine's make and model data, serial number, owner or user information, and/or other identifying information.

The operational information may include various machine operation information and capabilities, such as speed, torque, turn radius, size, PTO drive speed, sensor arrays, automation kits and control information and other information. Additional information may include operation information for the machine-specific tools, such as tool load type, movement range, lift loads, reach, operational speed ranges, interactive limitations, and other information. For machines that may use a variety of optional accessories, the relevant corresponding information for each optional accessory may also be stored. In some embodiments, the base information for the machine may be stored with information from each optional accessory to account for any changes to the machine operational information caused by connection to one accessory or another. In some embodiments, the optional accessories will include adjustment information that may be used during the analysis to update the machine operational information based on the connected accessory.

The machine information storage 108 may also include operational history of the machine, information regarding known wear and tear or damage to the machine or specific components, scheduling information or other information regarding the use or maintenance needs of the specific machine. The machine information may include additional information about the current status of the machine, such as location, battery or fuel levels, currently attached accessories, and other status information. In some embodiments, the types of information may be stored as separate records for independent access and analysis. The machine information may store telematic and usage records, which indicate historical operations, usage data and logs, and current status information.

The activity program storage 110 may include a selection of activity scripts for various working machine operations within the reusable asset storage 112 and the operational asset storage 114. The activity scripts may include program code to achieve specific activities by a machine. For example, one activity script may provide an initiation process for turning on a class of machines using a certain automation kit or electronic control unit. Some activity scripts may be operable by multiple machines while others are more limited. Some activity scripts may be machine-specific scripts.

As discussed further herein, the reusable asset storage 112 may store reusable digital assets, which include scripts, usable maps or paths, machine operation adjustments, implement control information or other data or code that may be applied to the originating machine or other machines. The reusable asset storage 112 may include additional definitions, parameters and compliance information associated with each reusable digital asset to identify the asset and whether it is applicable for a future project. For example, a reusable digital asset for transitions between two work zones may include an identifying title—e.g. “Field A to B transition”—and pertinent correlating data, including locations for Field A and B, any path limitations (such as maximum path width, weight limits, speed limitations, slope angles, know obstacles, etc.) and other characteristics to ensure compatibility with the program.

In some embodiments, reusable digital assets may provide specific paths and operations that may only be modified by triggered rule, such as an obstacle or safety sensor detection. These reusable digital assets may be considered hard assets. Hard assets are set features, such as boundaries, lines, curbs, waypoints, prescription maps, tram lines, controlled traffic paths and other set features in the reusable digital asset. Other reusable digital assets may include soft assets that permit flexibility and adaptive behaviors to allow the machine to adjust to the environment and the task.

In some embodiments, the reusable digital assets may include machine learning models that are configured to one or more sensor systems for a machine. The The system may include machine learning models for distinct location conditions or features to tailor the sensor operations for the specific application. For example, a machine learning system may develop perception sensor models trained for certain field conditions, such as a dry field with limited color, a temperate field with colorful conditions, or a wet field with colorful conditions and mud risk. Each model may be designed to configure the perception sensors and/or the perception sensor analysis to better identify obstacles, risks, boundaries, vegetation status and other information from the conditions in the field. As another example, the system may have a series of machine learning models for a machine vibration sensor or sensor array that are tailored to specific work options and/or implements. In some embodiments, machine learning models may be integrated with specific machine operational instructions to tailor responses to sensor information to the specific conditions.

In most embodiments, reusable digital assets will incorporate a combination of hard and soft asset features. For example, a reusable digital asset to transition between two fields may provide beginning and ending waypoints as hard assets and a known path indicator as a soft asset to allow the machine to determine a path based on a combination of perceived surroundings, surveyed boundaries, zones, lines and points combined with rules that are customized to fit the given operation. In such an embodiment, the machine may monitor for obstacles, other machines and other information to manage movement and avoiding collision on the fly.

In some embodiments, the reusable digital assets may be configured to machines and independent accessory implements. The reusable digital assets for each machine and implement may include detailed configuration information for that device. For example, a machine asset may include a configuration file for the operation speed, PTO output and other information. As another example, an implement digital asset may include a configuration file for operation power requirements, speed to task operation ratio, configuration dimensions (e.g., travel configuration size and operating size), movement limitations (such as a direction requirement for a side mower, one-way plow, harvester, etc.) and additional sensor options.

In some embodiments, the mission planning system 106 operates on the same structure, such as a server, with the machine information storage 108 and activity program storage 110. Within cloud structure 102, the mission planning system 106 may be connected to the machine information storage 108 or the activity program storage 110 over one or more communication systems depending on the underlying server array structure. For example, the mission planning system 106 may be implemented on a first server, using a processor and program memory connected via a wired bus. When evaluating machine information, the mission planning system 106 may use a first server communication card to access the Internet or other network in connection with the machine information storage 108.

In some embodiments, the processing operations may also be shared among multiple processors or separate computers to speed the evaluation through parallel processing operations. For example, when identifying applicable reusable assets, the mission planning system 106 may implement parallel processing of apportioned sections of the reusable asset storage 112 to identify potential reusable digital assets that correlate to a machine's characteristics. As another example, the mission planning system 106 may assign separate computers to parallel process two distinct project requests.

In this embodiment, the machine information storage 108 may receive data from the cloud management system 104 based on information from a machine data source 120. Embodiments of the system may include any number of machine data sources 120. The machine data source 120 may include external user interfaces, such as phones, computers, server systems, tablets and other devices, used by manufacturers, mechanics, machine users, aftermarket suppliers and other sources. In addition, machine information storage 108 may receive information from working machines 126 and 128 directly.

The activity program storage 110 may receive information from activity program source 122. In this embodiment, the cloud management system 104 facilitates the distribution of information to the activity program storage 110. The system may include additional activity program sources 122 in some embodiments. The activity program source 122 may be external user interfaces, such as phones, computers, server systems, tablets and other devices, used by any developer, programmer, manufacturer, user, aftermarket supplier or other entity that may prepare activity scripts for working machines. In some embodiments, the machine data source 120 and the activity program source 122 may be the operator of the cloud structure system 102.

In this embodiment, a single project request source 124 is identified. In other embodiments, a system may have multiple project request sources. The project request source 124 may be external user interfaces, such as phones, computers, server systems, tablets and other devices, used by any machine user or entity. In some embodiments the project request source 124 may be the operator of the cloud structure system 102. The cloud management system 104 may receive requests from the project request source 124 and direct the request to the appropriate mission planning system 106.

In some embodiments the mission planning system 106 or the cloud management system 104 may translate a project request into a standard format for the mission planning system 106 to parse and analyze. For example, the project request received from the project request source 124 may be a natural language request from the project manager, such as a request received in an audio format. The cloud management system 104 may convert the audio to text and identify the project definitions. In some embodiments, the cloud management system 104 may only convert the applicable key words for the project.

The mission planning system 106 may analyze the project request and evaluate the project definitions and goals to identify machine selection criteria (such as machine capabilities, locations, ownership limitations, scheduling availability, etc.), other fleet requirements, project operational areas, project timelines and other constraints, project goals and other project information.

In some embodiments, the project request may identify one or more machines that will be used on the project. In such embodiments, the cloud management system 104 may send a query to the machine information storage 108 to obtain machine profiles and status information for the specified machines. The cloud management system 104 may include the machine information with the project request that is sent to the mission planning system 106.

In other embodiments, the mission planning system 106 may access machine information storage 108 to review machine profiles and identify machines that fit a project request. In some embodiments, the mission planning system 106 may send a query to the machine information storage 108 requesting machine profiles that meet a requirement of the project. For example, if the project requires machines located around a specific area the machine planning system 106 will send a query to the machine information storage 108 requesting all machines that are within a certain radius of the project area. In some embodiments, receiving a select group of the machine profiles increases the efficiency in the processing analysis to identify which machines are appropriate for the project and reduce processing requirements for the machine information storage 108 to allow other parallel requests without overburdening machine information storage 108's processor.

In some embodiments, the mission planning system 106 may receive machine criteria requirements, location information and other information from the cloud management system 104's project request analysis. The mission planning system 106 may use the machine criteria requirements during the analysis of the machine profiles to identify preferred machines for a project. In some embodiments, the mission planning system 106 will identify the preferred machines based in part upon reusable digital assets associated with a location or other project feature. For example, if multiple options exist for the capabilities necessary to complete a project, the mission planning system 106 may determine which machines are compatible with an applicable reusable digital asset. In some embodiments, the mission planning system 106 may identify preferred machines based on sensor availability and condition-based machine learning models available for specific machines. For example, the mission planning system 106 may identify machines with a sensor array and machine learning model designed for a tiered environment to increase slope safety.

The mission planning system 106 may then select reusable digital assets from the reusable assets storage 112 that are consistent with the selected machine and applicable to the location, operation or other feature of the project. In some embodiments, the mission planning system 106 may compile applicable scripts from the reusable asset storage 112 using the machine information variables and any necessary conversions. For example, the reusable digital asset may have a default operation setting for machine A to achieve a set velocity, which must be converted for the selected machine B to achieve the same velocity. These conversions may be built into one or more configuration or information files that are used to compile scripts for the mission plan.

The mission planning system 106 may further select additional operational assets from the operational asset storage 114 to complete a mission plan. For example, if the mission planning system 106 identified reusable assets for traveling between work sites and paths within the work sites but did not identify reusable assets to control the implement operation, the mission planning system 106 may identify and incorporate the machine specific scripts for the implement operation from the operational asset storage 114.

In some embodiments, machine learning models may be operational assets stored within the operational asset storage 114. For example, machine learning models for managing operations in specific weather conditions may be general operational modification rules. As another example, the operational assets may include tailoreed machine learning models for maintenance evaluations through sensor activity in distinct operational conditions. These machine learning models may be applied as requested or based on additional machine or environment feedback. For example, the mission planning system 106 may include a specific machine learning model based on machine profile information, such as age or use information. The specific machine learning model may be tailored to the available sensors, the machine type and specific condition of the machine. For example, maintenance may be indicated for certain sensor readings in a machine having more operational hours than a new machine with limited prior use.

Once the activity scripts from reusable digital assets and operational assets are selected and compiled by the mission plan system 106, the mission planning system 106 may create additional necessary scripting to achieve the project and tie together the various activity scripts needed for each operation. If multiple machines are involved, the mission planning system 106 will create individual plans for each selected machine that are compiled to form a complete mission plan for the project. The mission planning system 106 may then issue the mission plan to each working machine 126 and 128. The mission plan communication may be sent using a communication system network card over one or more communication channels to the communication modules and electronic control units on each working machine 126 and 128.

Working machines 126 and 128 may be any number of working machines. In addition, working machine 126 and working machine 128 may be the same type of machine. For example, working machines 126 and 128 may both be tractors with mowers that are assigned to a common field to share the responsibility of mowing the entire field. In other embodiments, working machine 126 may be a distinct type of machine from working machine 128. For example, working machine 126 may be a forklift designed to move loads around at a worksite and working machine 128 may be a crane at the worksite designed to lift certain loads up to the higher levels of a building under construction.

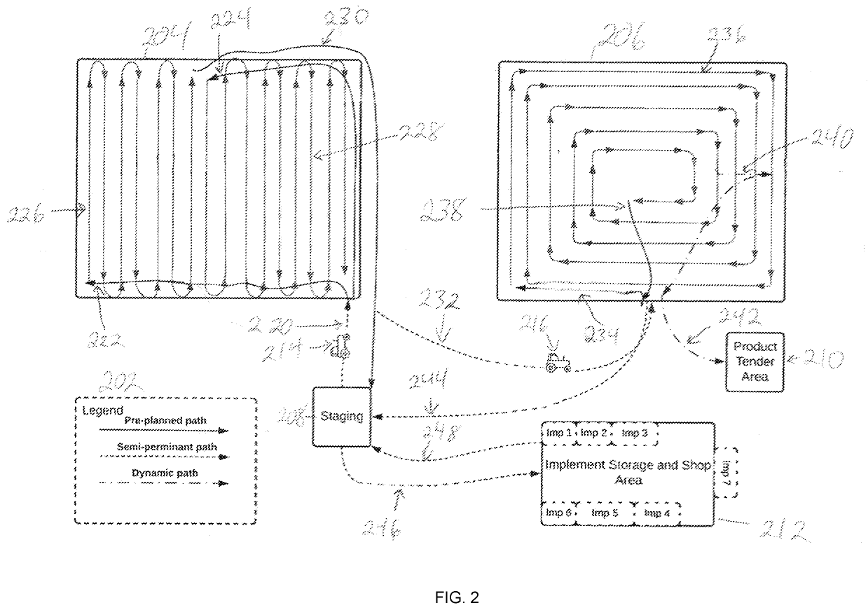

FIG. 2 shows a dynamic project map diagram illustrating mission planning options. This map shows an example of a multi-field project layout including preparation and completion options. A corresponding mission plan may use one or more reusable assets and operation instructions to guide the machines through the project tasks. In addition, a corresponding mission plan may identify rules that may be triggered to guide the machine though optional instructions built on operation or reusable assets.

The map includes a legend 202 illustrating distinct indication lines for pre-planned, semi-permanent and dynamic paths. The mission plan may similarly use pre-planned paths and semi-permanent paths for the primary instruction with some variation allowed by optional rules indicators for certain semi-permanent and dynamic path options.

In this embodiment, the map includes a first field 204 and a second field 206. Each field 204 and 206 has assigned work to complete for a project and may be referred to a work zone. The map also includes additional areas outside these fields 204 and 206, including a staging area 208, a product tender area 210 and an implement storage and shop area 212. In this embodiment, the map includes two machines shown as tractor 214 and tractor 216.

The map also includes a variety of paths between these various areas. In this embodiment, the map includes an entry path 220 from the staging area 208 to the first field 204, which is broken in two work sections. From this entry point in field 204, the tractor 214 may take a first ingress path 222 to a first work starting point or a second ingress path 224 to a second work starting point. In this embodiment, the first work starting point begins the operation for first path 226 covering the project for the first section of the first field 204. Similarly, work operations for the second portion of the field 204 begin at the second starting point and follow the second path 228. In this embodiment, each work path 226 and 228 is shown with a serpentine pattern of parallel columns that turn 180 degrees at each headland to traverse the field 204 in two sections. In this embodiment, the first work path 226 ends proximate to the start of the second work path 228. Those skilled in the art will recognize that these paths may vary in flow and direction depending on the field characteristics, boundaries, operations and timing. In addition, the field 204 may not be sectioned in some circumstances and may be managed in additional sections for other situations.

In the illustrated embodiment, the end of the first work path 226 leads to a first egress path 230 from the field 204 and back to the staging area 208 as part of a pre-planned path. In addition, the end of the second work path 228 ends at the entry point of the field 204, where a tractor 214 or 216 may back track the entry path 220 to the staging area 208. Alternatively, one of the tractors 214 or 216 may take the first transition path 232 to the second field 206 for further work. For discussion, we will follow tractor 216 along this option.

At the entry to the second field 206, the tractor 216 may follow the third ingress path 234 to the third starting point. In this example, the second field 206 only includes a single third work path 236 which proceeds in a concentric pattern reducing to the center of the field 206. The pre-planned third work path 236 ends in the center for operations and then proceeds along a third egress path 238 to the entrance of the field 206. The tractor 216 may follow the semi-permanent return path 244 to the staging area 208.

In the illustrated embodiment, a rules-based dynamic path is also illustrated for field 206 to facilitate a tendering operation when triggered. A tendering operation may include refueling, recharging, refilling a product to disperse (e.g., seed, fertilizer, water, pesticides, herbicides, other treatments, etc.) or other resupply options. As an example, for this embodiment, when the tractor 216 reaches a minimum threshold for fertilizer, the electronic control unit of the tractor pauses current work operations and follows the dynamic rule-based path 240 to egress the field 206 and proceeds on tender path 242 to the product tender area 210. At the tender area 210, the tractor 216 receives additional fertilizer to complete the project. Once additional fertilizer is received, the tractor 216 returns along the tender path 242 and dynamic rule-based path 240 to ingress across the field 206 to resume operations along the third work path 236 where the operations were stopped.

In addition, this embodiment includes a shop path 246 to the implement storage area 212 from the staging area 208 and a return shop path 208 from the implement storage area 212 back to the staging area 208. The implement storage and shop area 212 is illustrated with multiple implement areas where the tractors 214 or 216 may pick up or drop off implements for a project. In addition, this implement storage and shop area 212 may be a location for tractors 214 or 216 to be maintained or potentially stored between projects. In embodiments with the tractors 214 and 216 stored in the implement and shop area 212, the shop paths 246 and 248 may become part of the projects mission plan to direct the tractors 214 and 216 to the staging area 208.

These paths along with set locations may be built into reusable digital assets for assembling a mission plan. For example, a setup reusable asset may include instructions for driving on path 246 to the implement storage area to attach an implement and returning to the staging area over path 248. The reusable asset may be required to include multiple control and operation instructions to guide the tractor 214 through the multi-step process. In addition, the reusable asset may include place holders that must be filled in with information specific to tractor 214 from a configuration file. For example, the machine information for tractor 214 may include a configuration file having velocity control definitions, turning definitions, gear control definitions and additional control scripts or definitions that may be used by a reusable asset to implement the reusable asset on tractor 214. Similarly, a separate configuration file for tractor 216 may facilitate the use of the same reusable asset even if tractor 216's operations are different than tractor 214. In addition, the mission planning system uses the same reusable asset with a preconfigured modification to direct tractors 214 and 216 to different implement locations.

Additional reusable assets may provide instructions to travel the entry path 220, operation starting point transitions over first ingress path 222 or second ingress path 224. Similarly, the mission plan may include rules that identify and select additional operations that may be built on reusable assets. For example, when a mission plan incorporates the first egress path 230, the reusable asset may include the first egress path 230 travel instructions with a trigger-based rule to determine whether to return to the staging area 208 or transition to the second field 206 over transition path 232. In some embodiments, the trigger may be based on communication with another tractor to determine if any other tractor has proceeded to the second field 206. In other embodiments, the mission plan may preselect the tractor to proceed to the second field 206. The mission plan may still use the same reusable asset for the first egress path 230 and preselect the choice to follow the transition path 232.

In addition to potential paths and combinations that may be reusable digital assets, additional reusable assets may include topography adjustments, condition adjustments and other controls or adjustments. For example, the system may include a reusable digital asset for slope adjustments to manage driving on slopes in combination with PTO output adjustments to correlate operations with driving speed and angle. In addition, the adjustments may cover deck height or angle modifications for certain conditions or terrain. In some embodiments, the reusable digital assets may be implemented through modification rules triggered by a communication, a mission plan indication or a sensor reading. For example, if a sensor indicates that the tractor 214 is on an incline surpassing a threshold, the tractor 214 may initiate a slope modification provided by a reusable digital asset.

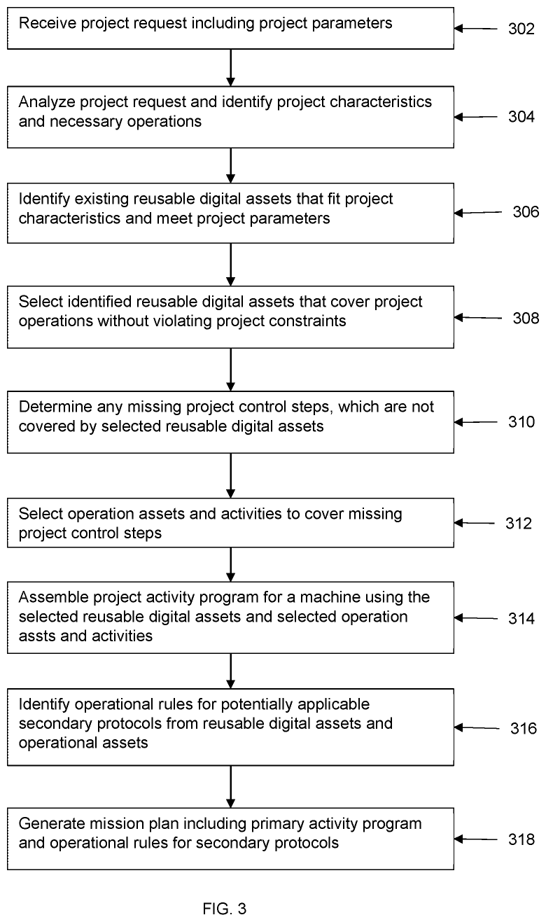

FIG. 3 provides a flowchart for a developing a mission plan using reusable digital assets. In box 302, the system receives a project request including project parameters. The mission planning system may receive the request directly in some embodiments. In other embodiments, the project request may come through other systems before reaching a mission planning system, such as a project management system or a cloud management system. The project request may be initiated by a project manager, field or equipment owner, an authorized user or other person. In some embodiments, the project request may be initiated through a computer system, which may have a calendared set of projects or an automation system to identify when to run certain projects.

In box 304, the project request is analyzed by the system to identify project characteristics and necessary operations. This analysis may occur within a mission planning system or another system in preparation for mission planning. The analysis may break down the request into applicable categories of information for the mission planning process. For example, a request for cutting a field for hay may be broken down into field identification information, identified tractor and implement, staging availability and other information. The information may be further broken down based on known information in the system about the information from the project request. For example, the system may include a machine profile that corresponds to an identified tractor and field details (e.g., entry locations, hard boundaries, topography, dimensions, etc.) corresponding to the identified field.

In addition to the identified work in a project request, necessary operations may include acquiring proper implements, transitions to staging areas, loading fuel or product or other ancillary operations needed to prepare for a project. In addition, the system may identify steps or needs for the project that a human may assist. For example, a machine may be in transit from a distant location on a truck or other delivery vehicle. As another example, a machine may require pre-operation maintenance.

In box 306, the system identifies existing reusable digital assets that fit the project characteristics and operations and meet the project parameters. In this step, the system may identify relevant reusable digital assets based on one or more applicable features. The system may approach the identification through one or more parallel perspectives corresponding to types of potential relevance tracked in the reusable digital asset identification information. For example, the system may include one or more index files that correlate each reusable asset by relevant location information, machine information and operation information. Some embodiments of the system may include more or less distinction to index the reusable assets. In some embodiments, an index system may be bypassed for a full database search. In other embodiments, the reusable assets may be indexed based on every characteristic provided.

For example, the system may begin by identifying reusable assets for the location. The system may identify the reusable assets that include identifying characteristics associated with the project field, such as a field identification, longitude and latitude identification, corresponding field dimensions and constraints, compatible topography and/or other characteristics. In some embodiments, the system may select reusable assets based on seasonal, weather or other information that indicates a current field condition. For example, the system may identify machine learning models for sensor systems to improve functional operations for a sloped wet pasture or a dry field. The machine learning model may be trained for the different conditions and control sensor settings, such as light settings for perception cameras, evaluation protocols, such as threshold settings for analyzing sensor array feedback, and response operations tailored to the field conditions.

As another example, the system may identify reusable digital assets for the identified machine and compatible machines. This may include identifying reusable digital assets for the specific machine, other machines with the same make and model and/or machines having compatible drive and operation characteristics.

As an additional example, the system may identify reusable digital assets that may be used for compatible operations. For example, the system may identify reusable assets for compatible driving speeds, PTO rates, transition patterns, deck heights and/or other operational features.

As those skilled in the art will recognize, the ability to identify compatible reusable assets will depend on the available details for the project and the identifying characteristics associated with a reusable digital asset file. In addition, the system may process all identification options to identify a preferred selection of options for further consideration and potential implementation. For example, a system may identify all options from location-based identification, machine-based identification and operation-based identification to form an overall subset of options from a reusable asset database. The system may then identify or prioritize the reusable digital assets from the overall subset of options that are common to all three categories. In some embodiments, a set of secondary options may be identified that do not meet all three categories but are not incompatible with any of the categories. This may occur where some reusable digital assets do not include certain identifying information that would create a match. For example, if a reusable digital asset does not include location-specific information for the field size as an identifying characteristic, the reusable digital asset may meet machine and operational requirements without the process being able to confirm if the field information is compatible. In such instances, the system may conduct a secondary review if the reusable digital asset becomes a preferred option. The secondary review may check the configuration or script files to determine if field size is variable and may be applied to the project.

In box 308, the mission planning system selects identified reusable digital assets that cover project operations without violating project constraints. In some embodiments, the mission planning system will select reusable digital assets from the identified reusable digital assets based on an analysis to determine the best fit for the project. The best fit may be selected based on project compatibility, scope of coverage for the project using reusable digital assets, application confidence and/or other information.

Project compatibility may be based on one or more of the match or similarity to the project machine, implements, operating location and other project characteristics. For example, a reusable digital asset for the same project field and machine type, and an implement with similar operations may have high project compatibility. Alternatively, a reusable digital asset for a compatible section of the field and a similar machine and a matching operation may have a lower project compatibility because the system will have to extrapolate to cover the full project field.

The amount of a project covered by one reusable digital asset may impact the selection. For example, a reusable digital asset that only covers operation instructions and requires driving, path layouts and other information to be included through other assets would provide less project coverage than a reusable digital asset that includes field driving and path information with corresponding operations. The mission planning system may be configured to prioritize more complete reusable digital assets where applicable.

In addition to considerations of project compatibility and coverage, the mission planning system may determine a confidence level that the reusable digital asset may be used in the project. This confidence level may be of increased importance depending upon the number of variables or modifications required to apply the reusable digital asset to the project mission plan. For example, a reusable digital asset for the same machine on the same field for a related task may have a high confidence level for success. In contrast, a reusable digital asset for a different machine on a similar dimensioned field completing an alternative task may have a lower confidence level even if conversions to certain characteristics make the reusable digital asset compatible.

Those skilled in the art will recognize that one or more of these considerations may overlap in whole or in part. These have been included to illustrate perspectives on the consideration of relevant factors that influence the selection of a best match for a project. In some embodiments, the asset storage system may include multiple viable reusable digital assets that would result in a successful project mission plan. For example, if the reusable digital asset storage includes a reusable digital asset combined operation for a machine to ingress a field, perform the task while traversing the field and egress to a storage location, and a series of reusable digital assets that each cover one portion of the process, selection of the single combined asset or the series of individual assets may result in an equally successful mission plan.

In some embodiments, the selection analysis may evaluate one or more factors to determine a compatibility score for a project. The compatibility score may then be used to select the reusable digital asset(s) for a project mission plan. For example, the mission planning system may provide a score for (1) the similarity of the machine, (2) the similarity of the project location, (3) the similarity of the operations, (4) the project coverage and (5) similarity of other features relevant to the evaluation. These scores may be consolidated into a compatibility score for the reusable digital assets. In some embodiments, the mission planning system may score reusable digital assets relevant to specific sections of a project to identify a series of reusable digital assets that may be combined to cover more of a project mission plan.

In box 310, the mission planning system determines any missing project control steps, which are not covered by the selected reusable digital assets. The mission planning system may identify project characteristics or necessary operations that are not covered by the reusable digital asset or series of reusable digital assets selected for the project. This identification may be through an analysis and comparison of the identified necessary operations from the beginning to the end of a project with the coverage of operations provided by the reusable digital assets. For example, the mission planning system may analyze necessary operations with reusable digital assets for the project. During the analysis, the mission planning system may determine that a series of transition operations between completing the field task and conducting an egress operation are not provided. These may include PTO shut-off operations, safety check operations, implement repositioning operations and/or transmission power adjustments to form a working operation to a driving only operation.

In box 312, the mission planning system selects appropriate operational assets and activities to cover mission project control steps. For example, the mission planning system may access or query an activity program storage to select scripts for various activities or operations. If the machine is located in a new location, the mission planning system may select operational assets to facilitate travel controls and create an appropriate path to a staging area to implement the travel controls. The operational assets or activity scripts may include travel safety configurations for the machine and any implement, driving operations configured to set safe speed and turns along an identified path, and staging set-up instructions to set the machine in place for the next step in the process, which may be scripts for a reusable digital asset or additional operational assets.

In box 314, the mission planning system assembles the project activity program for a machine using the selected reusable digital assets and operational assets. The project activity program provides the instructions to direct the machine's operations for the project. During the assembly, the instructions are laid out and tied together into an executable program. For example, the mission planning system may assemble scripts underlying the reusable digital assets and operational assets. In some embodiments, the scripts are compiled into a single mission script for the mission. In other embodiments, the mission planning system may further link asset scripts in operational order through script calls. Using calls, may allow a single script to be used multiple times through a mission. For example, the operational path may be provided through a first script to conduct a task along a straight segment and a headland turn may be provided by a second script. A mission script may alternate calls to the first script and the second script to cause the machine to traverse a field.

In some embodiments, the scripts may include variables that must be provided for accurate operation characteristics tailored to the scripting. For example, the script may be designed for a designated travel speed and operation speed to correlate the operation to the distance. For such scripts, the machine operation instructions may be provided through a variable to be replaced or a subroutine call within the script. For this example, the machine characteristics may include an operation-instructions to achieve certain speeds. During assembly, the operation-instructions for the designated travel speed will be provided by the machine characteristics. For example, the mission planning system may use a configuration file for the project machine to load machine characteristic scripts into the correct sections of the mission plan script.

In some embodiments, the mission planning system may create a tailored modification to correlate machine-specific instructions to the script designations. For example, if the designated machine travel distance in the script for a given implement is more than the project machine's operation instruction distance, the mission planning system may increase the machine speed to achieve the designated distance consistent with the script timing.

Similarly, the mission planning system may use a configuration file to supply project location information, operation adjustments and other for the script. For example, if the reusable digital asset provides a travel operation for straight path transitions, it may include a variable to define the travel distance. In such cases, the same reusable digital asset may be applied to multiple straight path transitions.

In some embodiments, one or more steps may be compiled into a fluid single operation. As an example, the mission planning system may identify missing operations, identify operational assets and assemble a mission plan from operational assets and the selected reusable digital asset(s) during the assembly stage. The mission planning system may begin a mission plan from the designated machine's starting point and select applicable assets from the initiation through the travel and task operations until the machine reaches a designated shut-off at the end of the project. The mission planning system may determine for each necessary operation if a selected reusable digital asset covers the specific operation. If not, the mission planning system selects or creates the operational asset for that specific action. This may repeat for each necessary operation through the project. As such, the mission planning system is conducting multiple steps for creating the mission plan at each necessary operation of the project.

In box 316, the mission planning system identifies operational rules for potentially applicable secondary protocols from reusable digital assets and operational assets. In some embodiments, operational rules may include one or more triggers that cause the machine to conduct an action. In some embodiments, the triggered action is part of the project activity program for the primary operations. For example, a reusable digital asset may include an operational rule that is triggered by a location sensor to indicate a turning point in the path. As another example, the primary protocols may include an implement control trigger that alters driving during an implement operation, such as wrapping and dropping a hay bail.

In this step, the mission planning system is identifying operational rules for secondary protocols. These secondary operational rules are related to actions that modify the primary operations from the project activity program. Modifications may be minor or significant depending on the operational rule triggered. For example, an obstacle safety protocol may rely on a sensor trigger to identify an obstacle and cause the machine to adjust or pause a route to avoid the obstacle. As another example, a weather sensor reading may identify unsafe conditions for the operation triggering a rule to stop the operation and potentially move to an identified safe location.

Secondary protocols may include necessary operational considerations, such as refueling, recharging, refilling product, fleet assignment and communications, and other operation features that are necessary or likely to occur. In addition, secondary protocols may include safety triggers and rules to address any safety concern. For example, the system may include a slope operation modification to prevent rollover, bottoming out or damage to the machine or implement. A slope operation modification may be triggered by a slope sensor and travel direction of the machine, wherein the rule is triggered if a slope surpasses a threshold for the current and anticipated travel direction.

In some embodiments, a series of secondary protocols may be included. For example, a slope sensor may be used to trigger an alternate operation to modify driving and implement operation to adjust for a slope, such as increased speed and reduced implement output to maintain preferred ratios for the implement application. This slope adjustment may be triggered when the slope sensor reaches a first threshold. If the slope sensor reaches a second threshold, the modifications may be designed for rerouting for safety instead of adjustments to continue the operation properly.

The mission planning system may identify the operational rules for secondary protocols by analyzing the project parameters, operations and characteristics including project machines, locations, implements and the selected reusable digital assets and operational assets. In some embodiments, the selected reusable digital assets may identify potential secondary protocols along with indicators for the system to consider. The indicators may include features that may be outside the operations of the reusable digital asset. For example, if the reusable digital asset provides an ingress route operation for a solid ground surface, the asset may indicate that a secondary protocol may be needed for a wet or sloped path to prevent getting stuck. The mission planning system may analyze the location information to determine if the ingress option is solid or could be degraded. If there is a potential for a degradation or challenge in the path, the mission planning system would select the secondary protocol, so that it is available if needed.

In some embodiments, a mission plan may include machine learning models that configure the sensor arrays to monitor for certain conditions and initiate secondary protocols when a condition is detected. The mission planning system may also incorporate machine learning models that correspond to sensor operations for detected conditions in all machines that proceed to the same location.

In some embodiments, safety protocols are tied to the machine, the location and/or an operation and will be automatically included in a mission plan. In other embodiments, the safety protocols may be selectively included based on an evaluation of the known information for the machine, location and operation. For example, if the mission planning system has access to a location's topography, only slope adjustments that are potentially applicable may be included. As another example, a mission planning system may not incorporate safety protocols that are redundant to the machine's existing safety systems or may interfere with a machine's internal safety systems. As another example, the mission planning system may identify operational models for sensor management and operational controls tailored to anticipated conditions based on external field condition information, such as recent weather conditions, seasonal information, user or machine feedback from the location. The operational models may be machine learning models trained on historical information correlating to similar expected conditions. These operational models may coordinate or modify one or more safety systems to improve safety for the given conditions. Improved and tailored machine learning models may improve safety response and reaction time based on tailored sensor management and evaluation.

The operational rules for secondary protocols may be selected from known reusable digital assets in some embodiments. For example, the mission planning system may identify secondary protocols and pull reusable digital assets that correspond to those protocols. If a reusable digital asset does not correspond to the secondary protocol, the mission planning system may determine the necessary operations for the secondary protocol and assemble a series of reusable digital assets to achieve the secondary protocol. In some embodiments, the mission planning system may have to assemble operational assets and activities into a secondary protocol.

In some embodiments, operational rules may include autonomy guidance to allow a machine to operate by sensor and onboard configurations while maintaining a reusable plan. In such embodiment, the onboard configurations may be able to manage movement and adaptions to the environment without requiring a modified mission plan or secondary operations. The operational rules may allow a threshold flexibility in operation by the autonomous machine and cause a redirection to the mission plan only when the thresholds are reached.

In box 318, the mission planning system generates a mission plan including the primary activity program and operational rules and triggers for secondary protocols. The mission planning system may include a script to instruct the machine to follow the primary activity program as a default, while monitoring potential triggers. The control script may be configured to pause a primary activity program if a trigger initiates a modification in the primary operation. This control script may resume once the modification is complete. In some embodiments, the control script is set to resume the primary program at the same point. In other embodiments, the modification may require the control script to shift the primary script execution to track the modification.

The generated mission plan may be stored in the system for later use or sent for application on a machine. The machine loading process may depend on the machine's capabilities and systems. In some embodiments, the mission planning system may facilitate a wireless communication over a cellular or other wireless communication network if the machine includes the corresponding network communication card and service. In some embodiments, the mission plan may be loaded onto the machine using a physical connection, such as a portable memory drive or a wired connection to a computer or internet interface. Some embodiments may use indirect communication over the communication network by implementing a combination of transmissions to load a mission plan. For example, a computer or mobile device near the machine may receive the mission plan packet over the Internet (via wired or cellular connection), and the mission plan may then be transmitted over a local communication network, such as a WiFi network, a Bluetooth network or another local network corresponding to the machine's communication capability. As another example, one machine may receive a plurality of machine mission plans over a communication network and then forward an applicable mission plan to each additional machine over a local communication network.

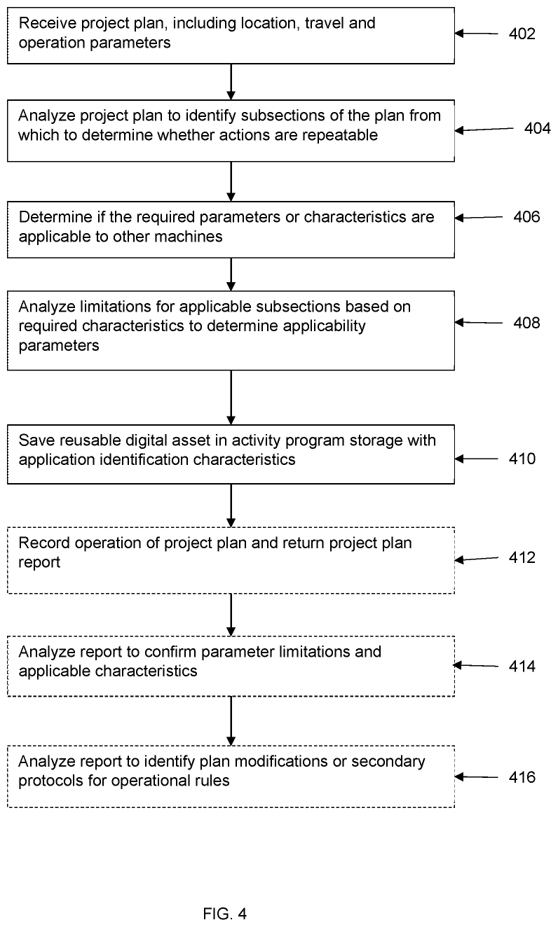

FIG. 4 illustrates a flowchart for creating reusable digital assets. This illustrates an option for creating reusable digital assets. Those skilled in the art will recognize alternative options for creating reusable digital assets from this description. For example, a reusable digital asset could be developed from live machine operation recordings that are converted into instruction sets and parameters. In this embodiment, the reusable digital assets are created from a project plan, which may be newly developed or provided by a machine after implementation.

In box 402, the system receives a project plan, including location, travel and operational parameters. The project plan may provide overall work guidance and parameters that are not converted to machine instructions for implementation. In some embodiments, the project plan may include the work guidance and parameters and encompass a mission plan that may be provided to one or more machines. In some embodiments, the system may be the cloud management system or the mission planning system. In other embodiments, an asset review system may be distinct within the cloud structure. The analysis system may be connected to or integrated with the activity program storage in some embodiments.

In some embodiments, the system may receive the project plan from a mission planning system as a compiled mission plan from which the work guidance and parameters may be determined. In some embodiments, the system may receive the project plan concurrently with the corresponding mission plan being sent to a machine for implementation.

In some embodiments, the system may receive a project plan from an operating machine. The project plan may be sent to the cloud structure for storage as a repeatable plan for that machine and simultaneously be received for review by the analysis system.

In box 404, the system analyzes the project plan to identify subsections of the plan from which to determine whether actions or operations are repeatable. In this step of the analysis, the system is identifying portions of the plan that may be repeatable on a broader application than just within the complete project plan.

In this embodiment, the system may distinguish features of the project plan by location distinctions, operation changes, machine requirement changes and other points of distinction. For example, the system may identify subsections based on identifiable location changes or movement shifts. This may reflect a transition between path types, such as a transition path to an ingress path or a work path to an egress path. For this example, the system may identify subsections for each type of path.

In some embodiments, the system may identify operation changes to identify alternative rules or subsections. For example, the system may identify a subsection of a project plan reflecting a triggered operation, such as a tendering operation. In this example, the tendering subsection may reflect multiple paths for the tendering operation. At the same time, the path-based subsection may identify each path used during the tendering process as a distinct subsection.

In addition, the system may identify project plan operations tied to select sensor readings as part of a distinct subsection. For example, if a section of the plan relies on tilt sensor readings to set an operation, the system may identify it as a subsection.

In box 406, the system determines if the required parameters or characteristics are applicable to other machines. In this step, the system is evaluating the operational parameters for the project plan to determine if other machines may be compatible with the project scope. The system may also determine if the operational parameters may be converted to make other machines compatible. In some embodiments, the system compares the characteristics of the machine for which the project plan was designed to other machines to identify if the features may be compatible.

In some embodiments, the system may identify project constraints or other requirements that may affect compatibility scope. For example, if the project plan identifies travel constraints on a path indicating a maximum width, the system would determine if such limitations are limited to the project machine or may be compatible with other machines. The same considerations could be applied to multiple features including speed, height, clearance, weight and other potential constraints. In addition to movement considerations, the project plan may include capability requirements that could frame maximum and minimum features for compatibility. For example, a compatible machine may be required to lift a certain weight for a hay moving operation.

Once the system determines that the subsection may be applicable for compatible machines, the system analyzes any limitations for identified applicable subsections based on required characteristics to determine applicability parameters in box 408. In this step, the system refines the compatibility potential to generate parameters to identify machine or location applicability for a reusable digital asset. The system may evaluate the machine limitations to determine machine identification parameters for a reusable digital asset. Similarly, the system may evaluate the location or operation limitations to determine identification parameters associated with compatible locations or operations for a reusable digital asset. In some embodiments, the determined parameters are part of a reusable digital asset's identification characteristics and used by a mission planning system subsequently when identifying potential reusable digital assets for a project.

In order to determine applicability parameters, the system may analyze the project plan to identify or determine machine limitations from the project plan. These identified machine limitations may be extrapolated to identify constraints on one or more machine feature. For example, if the project plan identifies travel constraints on a path indicating a maximum width between fences on a path, the system would require any compatible machine to meet the size requirements within the path width. The same considerations could be applied to multiple features including speed, height, clearance, weight and other potential constraints. In addition to movement considerations, the project plan may include capability requirements that could frame maximum and minimum features for a machine to be applicable. For example, a reusable digital asset for identifying and moving hay may require a lift load minimum.

In some embodiments, the system may determine whether the operation in the selected subsection may be scaled up or down to allow for additional machines to implement that section of a plan. For example, if a tractor and mower are designed for a specified power output and travel speed to cut a field, the system may identify other machine and mower combinations that are able to cut the field at a lower power and speed. These attributes may be convertible to allow compatibility with the overall project plan. If the attributes are scalable, the system may determine related parameters that are required in a machine for identified parameters. For example, the identification parameters may include a movement speed and implement power ratio that must be achievable. Those skilled in the art will recognize that this relationship may be expressed in multiple manners to allow for sliding scale relationships, locked ratios or other relationships between parameters.

In some embodiments, the analysis may determine that certain machine limitations from the project plan are preferred for the identifying parameters associated with the reusable digital assets. For example, if the project plan provides lifting to a minimum height for storage, a reusable digital asset that stores items in a similar structure may require the same minimum lift capability.

In some embodiments, the identified parameters may be variable and configured to work with the reusable digital asset through operation calls and characteristic constraints. For example, when the system identifies compatible machines or locations, the system may create a modification to the project plan to develop a reusable digital asset with a variable application based on machine specific information. This modification to the project plan may be implemented with modified scripts for a mission plan designed for a machine. In some embodiments, this information is built into a machine configuration file.

In some embodiments, the system will evaluate project plans to identify variable inputs that apply to other locations. For example, distances may be variable to allow the same reusable digital asset to apply to different transition paths using linear variations. Those skilled in the art will recognize that the variability may be direct variation for straight line paths connected by corner turns, while more complex paths may require additional detail to be variable. Similar variability may be applied to other location-based configurations and characteristics, such as speed, torque, carriage height and other characteristics.

In box 410, the system saves each reusable digital asset in activity program storage with application identification characteristics. In this step, the reusable digital assets generated from the project plan and analysis are stored for subsequent use. The reusable digital assets may be modified subsections of the project plan with variables built-in to account for application to other machines, locations and operations as applicable. In addition, the reusable digital assets are associated with identification characteristics to allow a mission planning system to subsequently and efficiently evaluate the applicability of each reusable digital asset to a future project.

The identification characteristics may include asset naming or descriptions, the determined applicability parameters for machines, locations and/or operations, and other information that may be used to identify a reusable digital asset. In some embodiments, the identifying characteristics will also be assembled into a storage index to allow efficient identification by a mission planning system.

In some embodiments, the stored reusable digital asset may include a configuration file requirement, which identifies necessary information from a mission planning system about a machine or location to facilitate use of the reusable digital asset. For example, if the reusable digital asset has a variable in the operation script for a PTO speed requirement for an implement, the associated configuration file requirement will list the PTO speed as a necessary data point to use the reusable digital asset. The mission planning system may review these configuration file requirements to ensure the proper information for the project is available before selecting the reusable digital asset for a project.

This embodiment illustrates additional optional operations for further development of the reusable digital assets in boxes 412, 414 and 416. These further developments contemplate evaluating actual operations to refine reusable digital assets.

In box 412, a machine records operation of a mission plan implementing the project plan and returns a project plan report. Those skilled in the art will recognize that these steps related to the project plan may occur at any time in the process, including before the project plan is received by the analysis system or concurrent with the analysis. Additionally, this recordation and report step may be applied to implementations of one or more reusable digital assets that have been created.

In this example, the project plan may have been sent to the analysis system to identify reusable assets in tandem with a corresponding mission plan's issuance to a machine for implementation. During the machine's implementation, the machine records the operational activities and sensor readings throughout the project operation. In addition to project plan operations, the recording may include any alterations to the operations, obstacle detections and/or other unexpected information. The sensor feedback may be used to identify field conditions and operational responses. Over time multiple recordings may be used to correlate operational responses to types of field conditions through machine learning analysis or other evaluations.

In some embodiments, the entire recording is returned as the project plan report. In other embodiments, the project plan report may be limited to information associated with specific actions or sensor readings. For example, the report may send recordings for actions taken including transitions from one path to another path, task operations shifting on or off, implement reconfigurations (e.g., raising or lowering the deck, lifting extensions for travel, etc.) or other actions. In addition, any unexpected sensor readings may cause the machine to include a snippet of the recording around the sensor readings in the report. Once the project plan report is created or assembled by the machine, the project plan report is returned to the cloud management system.

In box 414, the analysis system for generating and managing reusable digital assets analyzes the project plan report to confirm parameter limitations and applicable characteristics. In some embodiments, the analysis identifies actual feedback regarding one or more features of the operations. For example, if the sensors indicate physical barriers along an entry or transition path, the analysis system will determine available space for travel through the path. From the travel space, the analysis system may determine machine and implement size limitations. These may be compared to parameters in the corresponding reusable digital asset to confirm if the reusable digital asset's parameters are accurate.

In some embodiments, the report may also provide new information for evaluation. For example, tilt sensor readings through the report may provide more detailed topographical information that was previously unknown. The topographical information may also redefine necessary or preferred machine characteristics to account for the topography. For example, the system may identify a weight distribution parameter to limit the likelihood of a rollover or other damage.

In box 416, the system analyzes the project plan report to identify plan modifications or secondary protocols for operational rules. The system may review operation modifications that occurred during implementation, warning sensor readings and/or other indications that modification or secondary protocols are potentially warranted.

As an example, topographical information may be used by the analysis system to further tailor operations to improve machine movement and implement coordination. For a fertilizer application, this coordination may improve steady and even deposit of the fertilizer across the field.

For another example, the report may identify modified operations for obstacles. Based on an analysis and/or other feedback, the system may determine that the obstacle is permanent and identify potential preferred modifications to account for the obstacle. For example, the system may incorporate an adjusted path for the reusable digital asset. In addition, the system also adjusts the reusable digital asset to alter implement deposition operations for an herbicide application operation. In other embodiments, the system may insert a specific trigger associated with the specific location for the known obstacle to use a secondary protocol to circumvent the obstacle. The use of a trigger option may allow the reusable digital asset to be applied to other locations, which may not include such an obstacle. In some embodiments, the obstacle may be flagged for further review by the system or an operator to confirm the nature of the obstacle as a permanent or temporary obstacle.

In some embodiments, the analysis of the project plan report may indicate that a better operational plan may be needed. The report and any flagged new information may be provided to a mission planning system to develop an alternate plan to accomplish the project at that location. For example, if the project plan report indicates that the machine transversely climbing and declining a terraced topography, the analysis system may identify the operational challenges and send the report for an alteration. The mission planning system having the report may recognize that the topography is better suited for an alternative path to benefit from the terraced terrain.

In addition to project plan reports, the system may receive machine reports periodically that share operation information and feedback related to implemented applications of reusable digital assets. In some embodiments, the analysis system will review the report to determine if the reusable digital asset may be modified or improved based on feedback. Over time, the system may optimize the overall reusable digital asset. In some embodiments, the system may identify alternate optimizations for specific machine or location features. In such embodiments, the identifying data and configuration file structures may allow a reusable digital asset to apply multiple optimizations depending on the projected implementation.

In some embodiments, the reusable digital assets may be developed from human operated machine operations. The human operated machine operations may be recorded and sent to an analysis system to identify reusable assets. In some embodiments, the operator may indicate perceived beginning and end points for reusable information. The analysis system may review and evaluate the report to determine portions of the program may be converted to a reusable digital asset.

In some embodiments, the development of reusable digital assets may be based on combinations of rules to be applied for various applications. For example, an ingress and egress rule may direct ingress and egress paths to be within X feet of the field boundary. A refinement to the rule may require the path to use existing furrows or avoid crop sections. In such embodiments, modification rules may allow for path adjustment to fit the machine in the proper furrow paths.

In addition, fleet operations may require ingress and egress directions to coincide to prevent congestion. Similarly, fleet operation rules may include triggers to allow information from one machine to cause a secondary protocol in another machine. For example, if a first machine identifies an obstacle and sends the obstacle notice to other machines, a second machine may adjust to a secondary path to avoid the obstacle. In addition, fleet communication may rely on rules to adjust path selection to avoid unwanted interactions and ensure split work conditions are maintained. For example, selection of an ingress path may be tied to a defined work path, such that once a machine selects the ingress path other machines will not use that ingress path or work path.

In some embodiments, machine learning may be implemented to evaluate and develop one or more aspects of the reusable digital assets. For example, a machine learning system may be trained using existing project plans, machine characteristics, location information and operation reports. Once trained, the machine learning system may identify reusable digital assets that are widely applicable and likely to be successfully reused. In addition, the machine learning system may identify appropriate operational rules and triggers to improve applicability of the reusable digital assets. Similarly, machine learning may be implemented to create mission plans using reusable digital assets and operational assets.

In some embodiments, the machine learning systems may be trained to manage sensory systems for improved performance in specific conditions. Machine learning models may be developed for perception systems to improve environmental awareness for distinct operating conditions, which may relate to weather conditions, field health, coloring, seasons, topography, and other conditions. As an example, one machine learning model may be used when a working machine operates in a field having snow and another machine learning model may be used when the machine is operating in a colorful spring field. The model may include lighting configurations for the sensor operations tailored to the conditions and evaluate imagery and other sensory feedback to account for impact of snow verses colorful vegetation.

In some embodiments, different machine learning models for sensor management and feedback evaluation may be used for different machine-implement combinations. For example, a machine learning model may be used for real-time analysis of vibration sensor data for an implement, wherein the model is monitoring for vibration anomalies that may indicate a concern, error, impact, etc. The model may include operational responses based on distinct vibration anomalies, such as an emergency stop, a pause to adjust implement positioning, etc. A different machine learning model may be used for an implement that has distinct vibration characteristics, anomalies and appropriate responses. In some embodiments, the machine learning models may be further tailored to specific tasks or operations conducted by a machine-implement combination. For example, a machine with a posthole auger may be assigned a machine learning model tailored for the specific posthole auger model and the field soil characteristics.

Most of the equipment discussed above comprises hardware and associated software. For example, the typical working machine is likely to include one or more processors and software executable on those processors to carry out the operations described. We use the term software herein in its commonly understood sense to refer to programs or routines (subroutines, objects, plug-ins, etc.), as well as data, usable by a machine or processor. As is well known, computer programs generally comprise instructions that are stored in machine-readable or computer-readable storage media. Some embodiments of the present invention may include executable programs or instructions that are stored in machine-readable or computer-readable storage media, such as a digital memory. We do not imply that a “computer” in the conventional sense is required in any particular embodiment. For example, various processors, embedded or otherwise, may be used in equipment such as the components described herein.

Memory for storing software again is well known. In some embodiments, memory associated with a given processor may be stored in the same physical device as the processor (“on-board” memory); for example, RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such as a conventional rotating disk drive. All such memories are “machine readable” or “computer-readable” and may be used to store executable instructions for implementing the functions described herein.

A “software product” refers to a memory device in which a series of executable instructions are stored in a machine-readable form so that a suitable machine or processor, with appropriate access to the software product, can execute the instructions to carry out a process implemented by the instructions. Software products are sometimes used to distribute software. Any type of machine-readable memory, including without limitation those summarized above, may be used to make a software product. That said, it is also known that software can be distributed via electronic transmission (“download”), in which case there typically will be a corresponding software product at the transmitting end of the transmission, or the receiving end, or both.

The invention being thus described and further described in the claims, it will be obvious that the same may be varied in many ways. Such variations are not to be regarded as a departure from the spirit and scope of the invention, and all such modifications as would be obvious to one skilled in the art are intended to be included within the scope of the apparatus described.

1. A management system for automated work, comprising:
a networked server system, comprising:
a server communication card configured to communicate over a communication network,
a server memory, which comprises reusable digital asset storage, and
a server controller operatively connected to the server communication card and the server memory, the server controller is configured to manage the server memory drive and communication over the server communication card;
a working machine, comprising:
an application gateway having a first communication card configured to communicate over the communication network with the server communication card,
a machine control unit comprising a machine processor and a machine memory, which stores machine operating instructions, and
a machine actuator system having a machine control actuator; and
wherein the server controller receives a project request via the server communication card and analyzes the project request to determine a project operation, and wherein the server controller selects a reusable digital asset from the reusable digital asset storage that meets requirements for the project operation;
wherein a mission planning system of the networked server generates a mission plan for the working machine, wherein the mission plan includes machine instructions from the selected reusable digital asset and additional operational instructions.

2. The management system according to claim 1, wherein the additional operational instructions are selected from a second reusable digital asset from the reusable digital asset storage.

3. The management system according to claim 1, wherein the mission plan includes operational rules to guide the working machine's implementation of the mission plan.

4. The management system according to claim 3, wherein the operational rules are selected from another reusable digital asset from the reusable digital asset storage.

5. The management system according to claim 1, wherein the mission plan includes trigger-based operational rules to modify the working machine's implementation of the mission plan.

6. The management system according to claim 5, wherein the trigger-based operational rules are selected from another reusable digital asset from the reusable digital asset storage.

7. The management system according to claim 1, wherein the reusable digital asset from the reusable digital asset storage has been created from an analysis of a project plan by an analysis system, wherein the analysis identifies subsections of the project plan that are reusable for other project operations.

8. The management system according to claim 1, wherein the reusable digital asset comprises a machine learning model.

9. The management system according to claim 8, wherein the machine learning model is configured for execution by the machine control unit to manage a sensor array system of the working machine.

10. The management system according to claim 1, wherein the working machine includes a sensor array system connected to the machine control unit, and wherein the machine control unit applies the machine instructions based on the reusable digital asset to manage the sensor array system.

11. The management system according to claim 9, wherein the reusable digital asset comprises a machine learning model that is incorporated into the mission plan, and the machine control unit executes the machine learning model to configure the sensor array system.

12. The management system according to claim 10, wherein the machine control unit executes the machine learning model to analyze sensor data from the sensor array system.

13. A working machine for automated work, comprising:
an application gateway having a first communication card configured to communicate over a communication network with a networked server, which includes a server communication card and a server memory comprising reusable digital asset storage;
a machine control unit comprising a machine processor and a machine memory, which stores machine operating instructions; and
a machine actuator system having a drive control actuator;
wherein the application gateway receives a mission plan from the server over the communication network, wherein the mission plan is generated by the server to instruct the working machine to perform a project, and the mission plan includes machine instructions selected from a reusable digital asset from the reusable digital asset storage in the server;
wherein the machine control unit executes the machine instructions from the mission plan, and the machine actuator system controls the working machine in response to the machine instructions.

14. The working machine according to claim 13, further comprising a sensor array system connected to the machine control unit.

15. The working machine according to claim 14, wherein the reusable digital asset comprises a machine learning model that is included in the mission plan, and the machine control unit executes the machine learning model to configure the sensor array system.

16. The working machine according to claim 15, wherein the machine control unit executes the machine learning model to analyze sensor data from the sensor array system.
